(19) United States
(12) Patent Application Publication
(10) Pub. No.: US 2009/0031429 A1
(43) Pub. Date: Jan. 29, 2009

(54) Prevention of software and movie piracy

(76) Inventor: Nir Ben Zeev, Jerusalem (IL)

Correspondence Address: Gerald T. Shekleton, 22nd Floor, 120 South Riverside Plaza, Chicago, IL, 60606, US

(21) Appl. No.: 12/220,240

(22) Filed: Jul. 23, 2008

Related U.S. Application Data
(60) Provisional application No. 60/961,844, filed on Jul. 23, 2007.

(51) Int. Cl. G06F 21/00

(52) U.S. Cl. 726/27

(57) ABSTRACT

Preventing digital content piracy includes creating a predetermined pattern including at least one unreadable location on a target digital storage medium, which stores digital content and is configured to be received by a media reader. An error detection software program is provided on the target digital storage medium, which program is executed by a host processor, having an operating system kernel, when the host processor attempts to access the digital content on the target digital storage medium via the media reader. The program causes the host processor to query the media reader via a direct hardware connection independently of the operating system kernel, in order to identify the at least one unreadable location, and to access the digital content responsively to verifying that the identified location corresponds to the pattern.

### CROSS-REFERENCE TO RELATED APPLICATIONS

This application claims the benefit of U.S. Provisional Patent Application No. 60/961,844, filed Jul. 23, 2007, which is incorporated herein by reference.

### COPYRIGHT NOTICE

A portion of the disclosure of this patent document contains software code that is subject to copyright protection. The copyright owner has no objection to the facsimile reproduction by anyone of the patent document or the patent disclosure, as it appears in Patent and Trademark Office patent file or records, but otherwise reserves all copyright rights whatsoever.

### FIELD OF THE INVENTION

This invention relates to data disc storage media, and specifically to digital content copy protection.

### BACKGROUND

Copy-protection mechanisms are typically utilized to inhibit digital content piracy, in which unauthorized copies of commercial digital content, such as software or movies, are created. The purpose of digital content copy protection is to deter piracy by making copying of commercial digital content as difficult as possible. Some methods of protecting digital content encode data on a disc so that conventional copying facilities are unable to accurately copy the data to another disc. Typically, the digital media player or software checks for the encoded data, and fails to function unless the digital media player or software finds the encoded data.

U.S. Pat. No. 5,596,639, for example, describes techniques for selectively accessing data on a CD-PROM disk in a secure manner by selectively encoding binary digital passwords and decryption keys onto the same disk in a separate area. Passwords and decryption keys are programmed onto the disk after manufacture, such as at the point of sale, by selectively obliterating the readability of bits in addressable sectors. A binary digital key is then later recognized as the result of a string of addressable sectors, with the readable and unreadable sectors providing the digital string. In one embodiment, a manufacturer places several or all versions and features of a large program on a single CD-ROM, encrypted, and later provides keys to enable only selected ones of the features and versions for retrieval. The patent states that by programming a password or decryption key over an area of a programming region having a storage capacity of at least a megabyte, and in some cases several megabytes, existing methods of intercepting and defeating such security schemes may be defeated.

As another example, U.S. Pat. No. 4,584,641 describes techniques for protecting disks from being copied. Permanent random input/output errors, such as an absence of magnetic material, are placed on a disk by removal of material, or by other methods, and an input/output trap routine or program is placed on the disk. The input/output trap routine or program runs during the use of the user software program. A copied disk will not contain the permanent input/output error that existed on the original target disk because the input/output errors are not reproduced, since they are not machine readable. When the copied disk is run, the input/output trap routine cannot locate the permanent input/output error that existed on the original target disk.

### SUMMARY

In an embodiment of the present invention, a method is provided for preventing digital content piracy, which is carried out by creating a predetermined pattern including at least one unreadable location on a target digital storage medium, which stores digital content and is configured to be received by a media reader. An error detection software program is provided on the target digital storage medium and is executed by a host processor, which has an operating system kernel. When the host processor attempts to access the digital content on the target digital storage medium via the media reader, the error detection software program causes the host processor to query the media reader via a direct hardware connection, independently of the operating system kernel, in order to identify the at least one unreadable location, and to access the digital content in response to verifying that the identified location corresponds to the pattern.

In a disclosed embodiment, the predetermined pattern includes a number of sectors stored on the target digital storage medium, and the at least one unreadable location includes a damaged sector. Creating the predetermined pattern includes damaging at least one sector using a high-powered laser beam so as to render the at least one sector unreadable by the media reader. The target digital storage medium includes an optical disk, and the error detection software program causes the host processor to query the media reader using an Advanced Technology Attachment Packet Interface (ATAPI).

In some embodiments, the error detection software program causes the host processor to deny access to the digital content upon a failure to verify that the identified location corresponds to the predetermined pattern, to deny the access after waiting a random period of time following the failure to verify, and to verify the pattern multiple times while accessing the digital content.

An embodiment of the invention provides a product including a digital storage medium, which stores digital content and is configured to be received by a media reader, and which contains a predetermined pattern including at least one unreadable location, and which stores an error detection software program, which program is executed by a host processor, having an operating system kernel, when the host processor attempts to access the digital content on the target digital storage medium via the media reader, and causes the host processor to query the media reader via a direct hardware connection, independently of the operating system kernel, in order to identify the at least one unreadable location, and to access the digital content in response to verifying that the identified location corresponds to the pattern.

There is further provided, according to an embodiment of the present invention, a digital content copy protection system, including:

a recording device which is configured to store digital content on a target digital storage medium which is configured to be received by a media reader, and to create a predetermined pattern including at least one unreadable location on the target digital storage medium; and

a processor, which is configured to prepare the digital content for storage on the target digital storage medium, the digital content including an error detection software program, which program is executed by a host processor, having an operating system kernel, when the host processor attempts to access the digital content on the target digital storage medium via the media reader, and causes the host processor to query the media reader via a direct hardware connection, independently of the operating system kernel, in order to identify the at least one unreadable location, and to access the digital content responsively to verifying that the identified location corresponds to the pattern.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram that schematically illustrates an apparatus for producing digital media that are resistant to unauthorized copying, in accordance with an embodiment of the present invention;

FIG. 2 is a schematic, pictorial illustration of a digital storage medium, in accordance with an embodiment of the present invention;

FIG. 3 is a block diagram that schematically illustrates a system for playing back copy-protected digital content, in accordance with an embodiment of the present invention; and

FIG. 4 is a flow chart of a digital content copy protection method, in accordance with an embodiment of the present invention.

### DETAILED DESCRIPTION OF EMBODIMENTS

In the following description, numerous specific details are set forth in order to provide a thorough understanding of the present invention. It will be apparent to one skilled in the art, however, that the present invention may be practiced without these specific details.

### Overview

Embodiments of the present invention, as described hereinbelow, are directed to inhibiting piracy of digital content, such as software and movies, which are stored on digital media, particularly (although not exclusively) optical storage media such as compact discs (CDs) and digital video discs (DVDs). For this purpose, a pattern of one or more unreadable locations is stored on a target digital storage medium. In the embodiments that are described hereinbelow, the storage medium is assumed to be an optical disc as described herein, although the principles of the present invention are also applicable to media of other types.

In some embodiments, during the process of storing digital content on the optical disc, a certain set of sectors is set aside, unrelated to the digital content. The certain set of sectors may be identified via a table of contents stored on the optical disc as a pattern file. A number of sectors in the pattern file are rendered unreadable in the course of data storage or after data storage is complete. For example, a high-powered laser beam may be used to damage the sectors. Thus the pattern file on the optical disc comprises a predetermined pattern of readable and unreadable locations. Typical optical disc recorders are unable to replicate the pattern file when attempting to illegally duplicate the optical disc. A media reader, such as an optical disc drive, is able to read undamaged sectors in the pattern file on the optical disc, and identifies the undamaged sectors as readable locations. The media reader is unable to read damaged sectors in the pattern file on the optical disc, and identifies the damaged sectors as unreadable locations.

In embodiments of the present invention, an error detection software program is provided on the optical disc. A host processor has an operating system kernel, e.g., Microsoft Windows®, Unix®, or Linux®. The host processor executes the error detection program when a user attempts to access the digital content on the optical disc. The program queries the media reader to validate the pattern file. The query is sent by the host processor to the media reader via a direct hardware connection, independently of the operating system kernel, as described hereinbelow. The host processor receives the results directly from the media reader via the direct hardware connection. Direct communication between the host processor and the media reader hardware makes it significantly more difficult for hackers to make usable copies of digital content protected using the methods described herein. In particular, this direct communication, bypassing the operating system kernel, is helpful in inhibiting unauthorized tracing of pattern file verification activity.

When the host processor attempts to access the digital content on the optical disc, the error detection software program causes the host processor to query the media reader via the direct hardware connection. The error detection software program instructs the host processor to command the media reader to access the location of the pattern file in order to verify that the pattern file contains the expected pattern of readable and unreadable locations on the optical disc. The error detection software program instructs the host processor to have the media reader test each sector in the pattern file for readability, thus providing the pattern of readable and unreadable locations for analysis. The media reader responds by providing the host processor with the pattern of readable and unreadable sectors via the direct hardware connection, typically bypassing the operating system kernel and a device driver of the media reader.

Upon verifying that the optical disc contains the appropriate pattern, the error detection software program instructs the host processor to allow the digital content to be accessed. Otherwise, the error detection software program instructs the host processor to block access to the digital content.

In some embodiments of the invention, a media distributor may prevent piracy by using a unique pattern to protect each optical disc. A different pattern file is stored on each optical disc, along with the digital content and the error detection software program. Using the different pattern file for each optical disc provides additional protection for the digital content by helping to ensure that any breach of the unique pattern file typically limits the extent of the damage to a single copy of the digital content.

In yet another embodiment of the invention, the media distributor may prevent piracy by using a shared pattern to protect each optical disc. An identical pattern file is stored on each optical disc, along with the digital content and the error detection software program. Using the identical pattern file for each optical disc provides a significant decrease in the time required to produce each optical disc containing copies of the digital content and identical pattern file.

Typically, the error detection software program is integrated with the digital content, such as a commercial software application. In one example embodiment, the commercial software application executes the error detection software program in a randomized manner, so that each request to validate the pattern may originate from a different location in the code of the commercial software application.

In another example embodiment, notification of the commercial software program by the error detection software program of failure to locate the pattern does not result in an immediate failure of the commercial software application. The commercial software application may introduce a random delay before failing, helping to mask the exact location of the pattern validation in the commercial software application. These examples demonstrate methods of preventing tracing or “hacking” efforts by unauthorized entities from altering software applications in attempts to access digital content.

### Storing Protected Digital Content

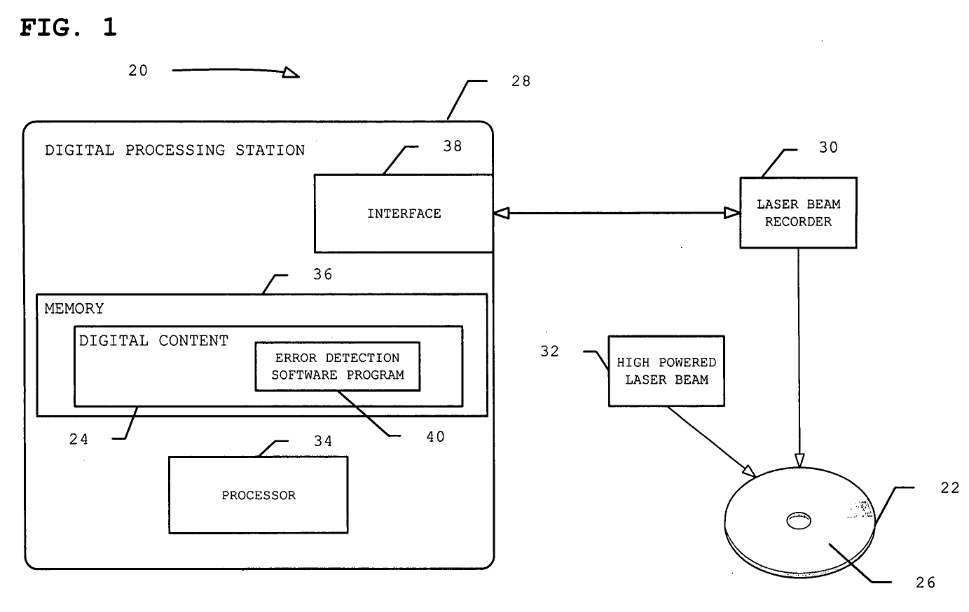

Reference is now made to FIG. 1, which is a block diagram that schematically illustrates an apparatus 20 for producing digital media that are resistant to unauthorized copying, in accordance with an embodiment of the present invention. Apparatus 20 is used to produce a digital media master mold 22 from digital content 24. The content is recorded on digital media master mold 22 in a data area 26. Digital media master mold 22 is then used in stamping copies of digital media master mold 22, based upon manufacturing methods well known in the art.

Apparatus 20 comprises a digital processing station 28, digital media master mold 22, a laser beam recorder 30 and a high-powered laser beam generator 32. Although recorder 30 and generator 32 are shown, for the sake of clarity of explanation, as separate units in FIG. 1, these functions may alternatively be combined in a single recording unit. Furthermore, although this embodiment relates to one particular method of producing digital media, the principles of data protection that are implemented in apparatus 20 may similarly be applied, mutatis mutandis, in other types of apparatus, using other data recording techniques.

Digital content 24 that is input to apparatus 20 is processed by digital processing station 28 to convert the content to an appropriate format for recording on disc, as is known in the art. Digital processing station 28 organizes the layout of the content on digital media master mold 22. Digital processing station 28 may comprise any suitable computer system that is known in the art, and typically comprises a host processor 34 and a memory 36, with an interface 38 to laser beam recorder 30.

Interface 38 may comprise a Bluetooth® adapter, an Infrared Data Association (IrDA) device, a cable connection, or any communication interface that allows digital processing station 28 to communicate with laser beam recorder 30.

Host processor 34 determines the data to be written to digital media master mold 22, as described hereinbelow. Digital content 24, which is held in memory 36, may comprise a commercial software program, a movie, or any digital content that may be stored on digital media master mold 22. An error detection software program 40 is also held in memory 36, and is recorded in data area 26 along with a pattern file 44, as described hereinbelow.

Host processor 34 typically comprises a general-purpose computer processor, which is programmed in software to carry out the functions that are described herein. The software may be downloaded to host processor 34 in electronic form, over a network, for example. Alternatively or additionally, the software may be provided on tangible media, such as optical, magnetic, or electronic storage media. Further alternatively, at least some of the functions of host processor 34 may be carried out by dedicated or programmable hardware.

Data from host processor 34 are passed to laser beam recorder 30, which writes the data to digital media master mold 22, as is known in the art. High-powered laser beam generator 32 may be used to render some of pattern file 44 on digital media master mold 22 unreadable, as described hereinbelow.

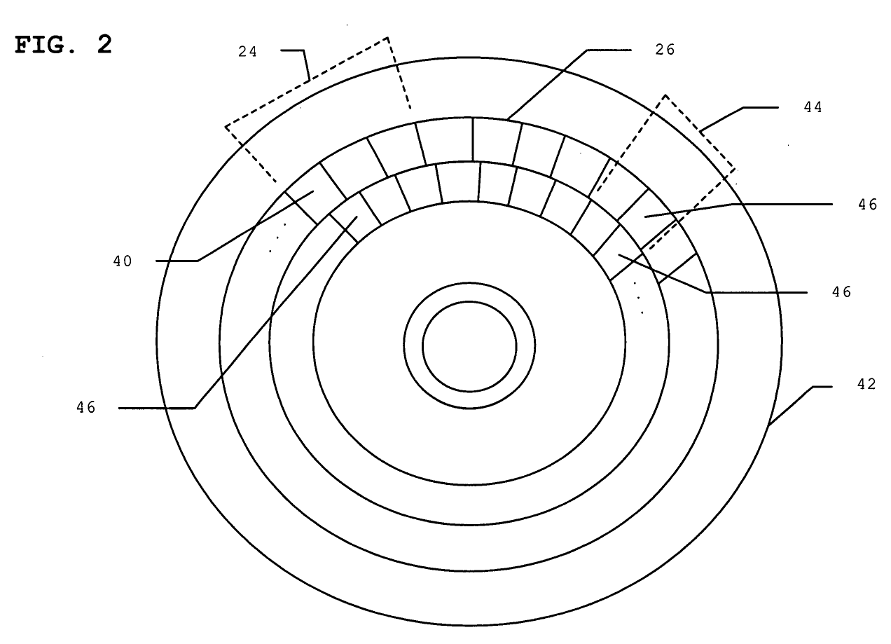

FIG. 2 is a schematic pictorial illustration of a target digital storage medium 42, which is produced from mold 22, in accordance with an embodiment of the present invention. Medium 42 is typically an optical storage medium, such as a CD or DVD, although the principles of the present invention may be applied, mutatis mutandis, to media of other types. Medium 42 contains digital content 24 in data area 26, as well as pattern file 44 and error detection software program 40 in other areas of the medium. Digital content 24 typically contains error detection software program 40. Pattern file 44 comprises a predefined pattern of readable and unreadable locations, as described hereinbelow.

A table of contents (not shown) on medium 42 lists the physical tracks where content 24, pattern file 44, and possibly other files are stored on the medium. Referring back to FIG. 1, processor 34 instructs laser beam recorder 30 to store digital content 24, pattern file 44, and error detection software program 40 on digital media master mold 22. Processor 34 provides error detection software program 40 with the location of pattern file 44 and with the details of the pattern itself to use when verifying that pattern file 44 on a copy of digital media master mold 22 contains the appropriate pattern as described hereinbelow. The pattern comprises damaged and undamaged sectors 46 in pattern file 44 stored on target digital storage medium 42.

High-powered laser beam generator 32 (FIG. 1) may be used to create the pattern by artificially damaging some of sectors 46 in pattern file 44 in mold 22. Alternatively, high-powered laser beam generator 32 or other means may be used to create the pattern directly on medium 42, or other methods may be used to render some of sectors 46 unreadable.

### Accessing Digital Content

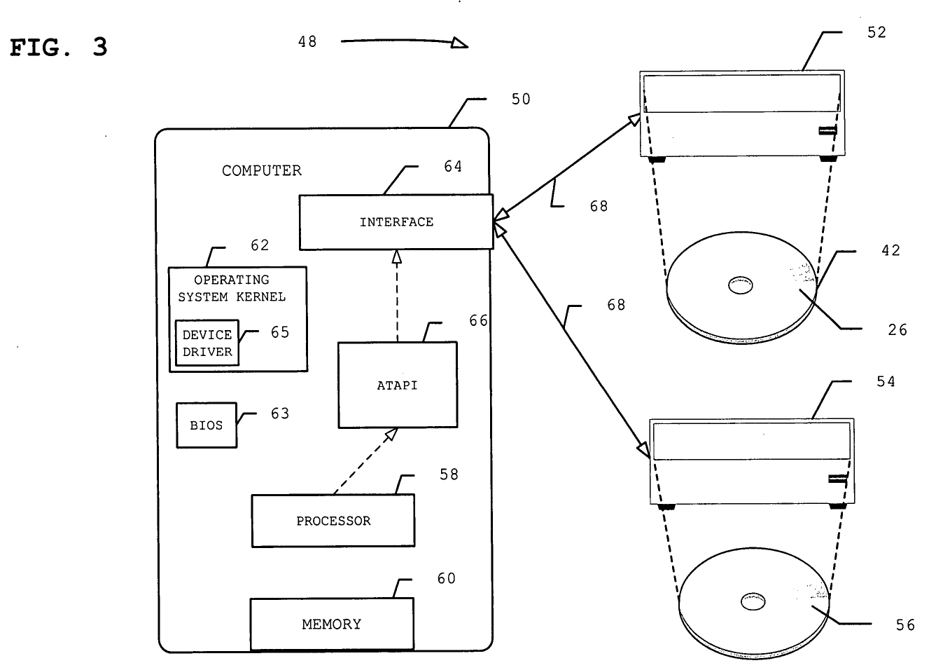

Reference is now made to FIG. 3, which is a block diagram that schematically illustrates a system 48 for playback of copy-protected digital content, in accordance with an embodiment of the present invention. System 48 comprises a computer 50 and a media reader 52 for reading target digital storage medium 42. In this example, the system also comprises a media storage device 54 for recording a blank digital storage medium 56, although such a device is not needed for playing back medium 42. Alternatively, the same device may be used for both reading and recording on digital storage media in system 48.

Computer 50 may comprise any suitable type of computer system that is known in the art, and typically comprises a processor 58 and a memory 60, which stores software including an operating system kernel 62. The computer connects to media reader 52 via an interface 64, using software provided in an Advanced Technology Attachment Packet Interface (ATAPI) module 66. ATAPI is described, for example, in “Information Technology—AT Attachment with Packet Interface—7 Volume 3—Serial Transport Protocols and Physical Interconnect (ATA/ATAPI-7 V3),” which is incorporated herein by reference. This document is promulgated by Technical Committee T13 of the InterNational Committee on Information Technology Standards (INCITS), and may be obtained from the T13 web site, t13.org. Interface 64 connects directly to media reader 52 via a cable 68, although alternatively other types of hardware connections (wired or wireless) may be used for this purpose. ATAPI module 66 provides processor 58 with the ability to communicate using an ATAPI protocol with media devices via direct hardware connections, independently of the operating system kernel, as described herein. However, other communication protocols that provide processor 58 with the ability to communicate with media devices via such direct hardware connections may alternatively be used.

Processor 58 typically comprises a general-purpose computer processor, which is programmed in software to carry out the functions that are described herein. A portion of the software—specifically, error detection software program 40 and possibly other executable code—is loaded by processor 58 from target digital storage medium 42, as described hereinbelow. Other software may be downloaded to processor 58 in electronic form, over a network, for example. Alternatively or additionally, the software may be provided on tangible media, such as optical, magnetic, or electronic storage media. Further alternatively, at least some of the functions of processor 58 may be carried out by dedicated or programmable hardware.

Error detection software program 40 causes processor 58 to query media reader 52 to validate that pattern file 44 on target digital storage medium 42 matches the pattern associated with digital content 24. Processor 58 uses ATAPI module 66 to issue a number of commands to media reader 52, described hereinbelow, without communicating via operating system kernel 62, a Basic Input Output System (BIOS) 63 of computer 50 or via a device driver 65 associated with media reader 52. The media reader is programmed in firmware to respond to the ATAPI commands. Thus, it is very difficult for a hacker to intervene and tamper in this interaction. An assembly code listing of a sample error detection software routine that may be used in this context is presented hereinbelow in Listing 1.

An attempt to replicate target digital storage medium 42 onto blank digital storage medium 56 by system 48, using media storage device 54, for example, will result in a copy of digital content 24 that will not be accessible for subsequent use, because error detection software program 40 will disallow access to the digital content. Conventional media storage devices are able to store digital content 24 and error detection software program 40 on blank digital storage medium 56. However, media storage device 54 is typically unable to successfully replicate pattern file 44, including damaged sectors 46, onto blank digital storage medium 56. The inability to replicate pattern file 44 is because the device lacks means for artificially damaging sectors 46. Thus, a copy of pattern file 44 stored by media storage device 54 on blank digital storage medium 56 will not be identical to pattern file 44 on target digital storage medium 42.

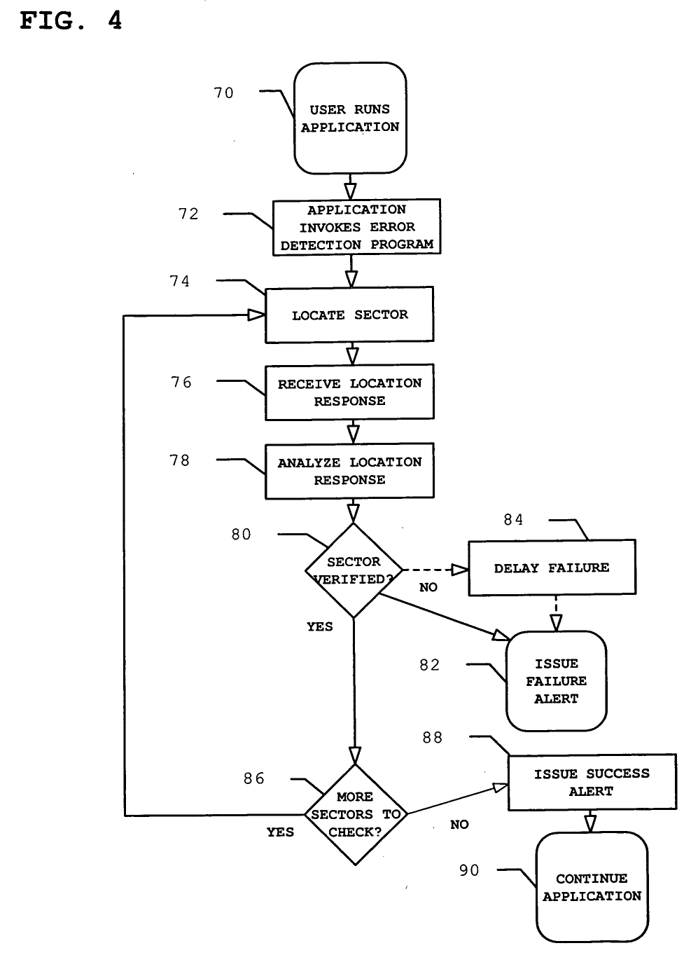

Reference is now made to FIG. 4, which is a flow chart that schematically illustrates a method for protecting digital content in accordance with an embodiment of the present invention. The method is initiated whenever a user of computer 50 tries to access digital content 24 by running the commercial software application, in an application running step 70. The user places target digital storage medium 42 into media reader 52, and the contents of target digital storage medium 42 thus become accessible to computer 50.

Computer 50 begins to execute the commercial software application, either automatically or under user control, to access digital content 24. Prior to actual execution, the software application invokes error detection software program 40, at an invocation step 72. Error detection software program 40 commands processor 58 to send a query to media reader 52 to determine whether media reader 52 is available. Once media reader 52 is available, error detection software program 40 allocates media reader 52. Media reader 52 is thus under the control of error detection software program 40, waiting for commands from error detection software program 40 and inhibited from responding to commands sent by other applications or processes.

Error detection software program 40 commands processor 58 to send an ATAPI command to media reader 52 to position the pickup head next to pattern file 44. Once media reader 52 is available, error detection software program 40 commands processor 58 to request media reader 52 to locate a sector in pattern file 44 on target digital storage medium 42, in a sector locating step 74. Processor 58 sends the request to media reader 52 using the ATAPI protocol with any suitable addressing format that is supported by the protocol.

In one example embodiment, processor 58 may instruct media reader 52 to locate the sector by providing a specific sector address. In another example embodiment, processor 58 may instruct media reader 52 to locate the sector by providing a “Minute Second Frame” (MSF) formatted address.

Typically, error detection software program 40 commands processor 58 to request media reader 52 to locate undamaged sectors in pattern file 44, in addition to locating damaged sectors in pattern file 44. Error detection software program 40 commands media reader 52 to attempt to locate undamaged sectors in pattern file 44 to decrease the likelihood that an unauthorized target digital storage medium 42 will be incorrectly verified by error detection software program 40 when every sector in pattern file 44 is damaged.

In a location response receiving step 76, processor 58 receives a response from media reader 52 indicating whether the sector has been located. When media reader 52 successfully locates the sector as described hereinbelow, the pickup head of media reader 52 is thereby located at the sector. The response is provided in a status register of media reader 52 and varies according to the operation code that was sent by processor 58 to media reader 52. Some examples of the response provided when the sector is not located are described hereinbelow.

In a sector analyzing step 78, processor 58 analyzes the response from media reader 52 in step 76, and, based on this response, determines the status of the sector located in step 74. If the response to the sector location request sent by processor 58 to media reader 52 comprises the location of the sector in pattern file 44 on target digital storage medium 42, processor 58 determines that the sector is undamaged. Alternatively, the response received from media reader 52 may comprise an ATAPI error message indicating that media reader 52 is unable to locate the sector or that the sector is damaged. For example, processor 58 may receive the error message “Bad Sector (34:54)” from media reader 52. In another example, the ATAPI error message indicates that the sector has been found, but the sector is damaged, typically when the address of the sector is undamaged, but the data of the sector is damaged. Upon receiving the error message from media reader 52, processor 58 determines the sector to be damaged or unreadable. The ATAPI error message is received from media reader 52 only when the sector is actually damaged, since the error message refers to a specific sector and a precise location on target digital storage medium 42. Since processor 58 communicates with media reader 52 through a direct hardware connection (via interface 64 and cable 68 in this example), using ATAPI to bypass operating system kernel 62, the possibility of unauthorized alteration of the response sent from media reader 52 to processor 58 is highly unlikely. The ATAPI response from media reader 52 originates in the internal integrated circuits of media reader 52 and may be modified only by physical alteration of the internal integrated circuits, which would damage normal operation of media reader 52.

In a sector verifying step 80, error detection software program 40 commands processor 58 to verify that the sector status matches the predefined pattern for the sector. If the sector is readable by media reader 52 when the pattern demonstrates that the sector should be damaged, or the sector is unreadable when the pattern demonstrates that the sector should be undamaged, error detection software program 40 instructs processor 58 to issue a failure alert, in a failure alert issuing step 82. The failure alert typically causes the commercial software program to deny access to digital content 24, by shutting down or by performing other actions described hereinbelow. It will be apparent to one skilled in the art, however, that alternative methods may be used to cause the commercial software program to deny access to digital content 24.

For example, when a malicious user attempts to access digital content 24 on an illegitimate copy of target digital storage medium 42, the commercial software program will execute error detection software program 40 to verify that the medium contains the expected pattern of damaged sectors. Upon detecting that pattern file 44 on the copied storage medium does not match the pattern, error detection software program 40 issues the failure alert to the commercial software program, which denies access to digital content 24 by the malicious user at step 82.

In some embodiments of the present invention, when the commercial software program receives the failure alert from error detection software program 40, the commercial software program delays denying access to digital content 24 or shutting down for a random period of time or a random number of program instructions in a failure delaying step 84. Since the commercial software application continues to function normally for a random period of time in response to the failure alert, the point at which the commercial software application fails varies, thus increasing the difficulty of hacking the commercial software program. After the optional delay, the commercial software program shuts down or otherwise denies access to digital content 24.

If the sector matches the expectation provided by the pattern for the sector, error detection software program 40 commands processor 58 to determine whether there are additional sectors from the pattern that need to be verified, in an additional sector checking step 86. If there are additional sectors from pattern file 44 that error detection software program 40 has not yet verified, the next sector is located in sector locating step 74.

When all of the sectors in pattern file 44 have been verified, error detection software program 40 reports that the medium in media reader 52 is legitimate, in a success alert issuing step 88. The application initiated at step 70 then proceeds to run normally in an application continuing step 90. In some embodiments, the software application may invoke error detection software program 40 multiple times during operation of the application.

In some embodiments of the present invention, multiple variations of digital media master mold 22 are created. Each variation comprises an identical copy of digital content 24 and error detection software program 40. However, a different pattern file 44 is stored on each variation of digital media master mold 22, and a single copy is made for distribution using methods described hereinabove. Using multiple variants of pattern file 44 for each target digital storage medium 42 provides additional protection for digital content 24 by helping to ensure that any breach of a unique pattern file by the hacker typically limits the extent of the damage to a single copy of digital content 24.

In an alternative embodiment of the present invention, all copies of target digital storage medium 42 are made using a single digital media master mold 22, so that each target digital storage medium 42 contains an identical copy of pattern file 44. Using identical copies of pattern file 44 for each target digital storage medium 42 copied from a single digital media master mold 22 provides a significant decrease in the time and expense required to produce each target digital storage medium 42.

In yet another embodiment of the present invention, calls to execute error detection software program 40 by the commercial software application which is used to access digital content 24 or is a part of digital content 24 are made from multiple locations in the application code. Calls to error detection software program 40 by the commercial software application may also be performed using different methods in order to defeat hacking of the commercial software application to intercept or to divert calls to error detection software program 40. In one example embodiment, processor 58 sends different ATAPI commands to media reader 52 when invoking error detection software program 40. In another example embodiment, the order of the ATAPI commands is varied so that each invocation of error detection software program 40 is dissimilar. In yet another example embodiment, all ATAPI commands are sent by processor 58 to media reader 52 separately so that each is encapsulated in a singular fashion.

Additionally or alternatively, the commercial software application issues “dummy” commands to error detection software program 40. The dummy commands induce error detection software program 40 to command media reader 52 via ATAPI module 66 to perform simple queries using the ATAPI protocol. The dummy commands do not validate media reader 52 against the pattern. Interspersing dummy commands with genuine queries to media reader 52 within the commercial software application may help to inhibit piracy of digital content 24 by increasing the difficulty for hackers to determine which calls to media reader 52 by error detection software program 40 should be intercepted.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

COMPUTER PROGRAM LISTINGS
Listing 1

| read_msf proc | | | |
|---|---|---|---|
| | push ax | | |
| | push bx | | |
| | push cx | | |
| | push dx | | |
| | mov dx,1f7h | | |
| loop12: | | | |
| | in al,dx | | |
| | and al,80h | | ;BSY bit |
| | jnz loop12 | | |
| | cli | | |
| | mov dx,1f7h | | |
| loop22: | | | |
| | in al,dx | | |
| | and al,40h | | ;DRDY bit |
| | jz loop22 | | |
| | mov dx,1f6h | | |
| | mov al,10h | | ;drive num |
| | out dx,al | | |
| | mov dx,3f6h | | |
| | mov al,02h | | ;set nIEN |
| | out dx,al | | |
| | mov dx,1f7h | | |
| | mov al,0A0h | ;sending packet | |
| | out dx,al | | |
| | mov cx,0ffffh | | |
| wait2: ;waiting loop | | | |
| | nop | | |
| | loop wait2 | | |
| | mov dx,1f7h | | |
| loop32: | | | |
| | in al,dx | | |
| | and al,80h | | ;BSY bit |
| | jnz loop32 | | |
| loop42: | | | |
| | in al,dx | | |
| | and al,08h | | ;DRQ bit |
| | jz loop42 | | |
| | mov dx,1f0h | ;------------------------- | |
| | mov ax,00b9h | | ; |
| | out dx,ax | ; | |
| ; sending the command | | | |
| | mov dx,3f6h | ; | |
| | in al,dx | ; | |
| ; packet to the device | | | |
| | mov dx,1f0h | ; | |
| | mov ah,[m_add] | | ; |
| | mov al,00 | ; while waiting one I\O | |
| | out dx,ax | ; | |
| ; | | | |
| | mov dx,3f6h | ; between each send | |
| | in al,dx | ; | |
| ; | | | |
| ; using the m_add | | | |
| | mov dx,1f0h | ; s_add | |
| | mov ah,[f_add] | | ; f_add |
| | mov al,[s_add] | | ; |
| | out dx,ax | ; | |
| ; fields to determine the | | | |
| ; | | | |
| | mov dx,3f6h | ; specific sector | |
| | in al,dx | ; | |
| ; | | | |
| | mov dx,1f0h | ; | |
| | mov ah,[s_add] | | ; |
| | mov al,[m_add | | ; |
| | out dx,ax | ; | |
| ; | | | |
| | mov dx,3f6h | ; | |
| | in al,dx | ; | |
| ; | | | |
| | mov dx,1f0h | ; | |
| | mov ah,00h | | ; the last sector num is |
| | add [f_add],1 | | ; the f_add + 1 and after |
| | mov al,[f_add] | | ; that returning the |
| | sub [f_add],1 | | ; field to original |
| | out dx,ax | ; | |
| ; | | | |
| | mov dx,3f6h | ; | |
| | in al,dx | ; | |
| ; | | | |
| | mov dx,1f0h | ; | |
| | mov ax,0000h | | ; |
| | out dx,ax | ; | |
| ; | | | |
| | mov dx,3f6h | ; | |

| | |
|---|---|
| in al,dx | ; waiting 2 I\O circ |
| in al,dx | ;------------------------- |
| mov dx,1f7h | |
| in al,dx | |

| | | |
|---|---|---|
| | and al,01h | ;ERR bit |
| | jnz io_err | |
| loop52: | | |
| | in al,dx | |
| | and al,80h | ;BSY bit |
| | jnz loop52 | |
| drq_chk: | | |
| | mov dx,1f0h | |
| | in al,dx | |
| bsy_chk: | | |
| | mov dx,1f7h | |
| | in al,dx | |

| | |
|---|---|
| test al,01h | ;ERR bit |
| jnz io_err | |
| test al,80h | ;BSY bit |
| jnz bsy_chk | |

| | | |
|---|---|---|
| | and al,08h | ;DRQ bit |
| | jnz drq_chk | |
| | sti | |
| | pop dx | |
| | pop cx | |
| | pop bx | |
| | pop ax | |
| | ret | |
| io_err: | | |
| | pop dx | |
| | pop cx | |
| | pop bx | |
| | pop ax | |
| | ret | |
| finish: | | |
| | int 16h | |
| | pop dx | |
| | pop cx | |
| | pop bx | |
| | pop ax | |
| | ; ret | |
| | mov ah,4ch | |
| | int 21h | |

read_msf endp

1. A method for preventing digital content piracy, comprising:
creating a predetermined pattern comprising at least one unreadable location on a target digital storage medium, which stores digital content and is configured to be received by a media reader; and
providing an error detection software program on the target digital storage medium, which program is executed by a host processor, having an operating system kernel, when the host processor attempts to access the digital content on the target digital storage medium via the media reader, and causes the host processor to query the media reader via a direct hardware connection, independently of the operating system kernel, in order to identify the at least one unreadable location, and to access the digital content responsively to verifying that the identified location corresponds to the pattern.

2. The method according to claim 1, wherein the predetermined pattern comprises a number of sectors stored on the target digital storage medium, and wherein the at least one unreadable location comprises a damaged sector.

3. The method according to claim 2, wherein creating the predetermined pattern comprises damaging at least one sector using a high-powered laser beam so as to render the at least one sector unreadable by the media reader.

4. The method according to claim 1, wherein the target digital storage medium comprises an optical disk.

5. The method according to claim 1, wherein the error detection software program causes the host processor to query the media reader using an Advanced Technology Attachment Packet Interface (ATAPI).

6. The method according to claim 1, wherein the error detection software program causes the host processor to deny access to the digital content upon a failure to verify that the identified location corresponds to the predetermined pattern.

7. The method according to claim 6, wherein the error detection software program causes the host processor to deny the access after waiting a random period of time following the failure to verify.

8. The method according to claim 1, wherein the error detection software program causes the host processor to verify the pattern multiple times while accessing the digital content.

9. A product comprising a digital storage medium, which stores digital content and is configured to be received by a media reader, and which contains a predetermined pattern comprising at least one unreadable location, and which stores an error detection software program, which program is executed by a host processor, having an operating system kernel, when the host processor attempts to access the digital content on the target digital storage medium via the media reader, and causes the host processor to query the media reader via a direct hardware connection, independently of the operating system kernel, in order to identify the at least one unreadable location, and to access the digital content responsively to verifying that the identified location corresponds to the pattern.

10. The product according to claim 9, wherein the predetermined pattern comprises a number of sectors stored on the target digital storage medium, and wherein the at least one unreadable location comprises a damaged sector.

11. The product according to claim 10, wherein the pattern is created by damaging at least one sector using a high-powered laser beam so as to render the at least one sector unreadable by the media reader.

12. The product according to claim 9, wherein the target digital storage medium comprises an optical disk.

13. The product according to claim 9, wherein the instructions cause the host processor to query the media reader using an Advanced Technology Attachment Packet Interface (ATAPI).

14. The product according to claim 9, wherein the instructions cause the host processor to deny access to the digital content upon a failure to verify that the identified location corresponds to the predetermined pattern.

15. The product according to claim 14, wherein the instructions cause the host processor to deny the access after waiting a random period of time following the failure to verify.

16. The product according to claim 9, wherein the instructions cause the host processor to verify the pattern multiple times while accessing the digital content.

17. A digital content copy protection system, comprising:
a recording device which is configured to store digital content on a target digital storage medium which is configured to be received by a media reader, and to create a predetermined pattern comprising at least one unreadable location on the target digital storage medium; and
a processor, which is configured to prepare the digital content for storage on the target digital storage medium, the digital content comprising an error detection software program, which program is executed by a host processor, having an operating system kernel, when the host processor attempts to access the digital content on the target digital storage medium via the media reader, and causes the host processor to query the media reader via a direct hardware connection, independently of the operating system kernel, in order to identify the at least one unreadable location, and to access the digital content responsively to verifying that the identified location corresponds to the pattern.

18. The digital content copy protection system according to claim 17, wherein the predetermined pattern comprises a number of sectors stored on the target digital storage medium, and wherein the at least one unreadable location comprises a damaged sector.

19. The digital content copy protection system according to claim 18, wherein the recording device is configured to generate a high-powered laser beam, which creates the predetermined pattern by damaging at least one sector so as to render the at least one sector unreadable by the media reader.

20. The digital content copy protection system according to claim 17, wherein the target digital storage medium comprises an optical disk.
